(19) United States
(12) Patent Application Publication
(10) Pub. No.: US 2025/0305532 A1
(43) Pub. Date: Oct. 2, 2025

(54) Grommet and Fastening Assembly

(71) Applicant: Illinois Tool Works Inc., Glenview, IL (US)

(72) Inventors: Hao Kong, Shanghai (CN); Xing Wang, Shanghai (CN)

(21) Appl. No.: 19/095,856

(22) Filed: Mar. 31, 2025

(30) Foreign Application Priority Data
Apr. 2, 2024 (CN) 202410396030.2
Mar. 21, 2025 (CN) 202510340443.3

(51) Int. Cl. F16B 21/07; F16B 5/06

(52) U.S. Cl. CPC F16B 21/075; F16B 5/065

(57) ABSTRACT

The present disclosure provides a grommet including a body, at least one first retaining portion, at least one second retaining portion and at least one operating portion. The body defines a receiving channel and a longitudinal axis, and includes a first axial body portion and a second axial body portion. The first axial body portion includes at least one first body segment and at least one second body segment disposed about the axis and spaced apart. The first retaining portion is provided on a side of the first body segment facing away from the axis. The second retaining portion is provided at an end of the second body segment away from the second axial body portion and extends away from the axis. The operating portion is provided at an end of the first body segment away from the second axial body portion and extends away from the axis.

### GROMMET AND FASTENING ASSEMBLY

The present application claims the benefit of Chinese Patent Application Nos. 202410396030.2, filed Apr. 2, 2024, and 202510340443.3, filed Mar. 21, 2025, each titled “Grommet and Fastening Assembly,” the contents of which are hereby incorporated by reference.

### TECHNICAL FIELD

The present disclosure generally relates to a grommet, and particularly to a grommet used in cooperation with a pin, and a fastening assembly including the grommet.

### BACKGROUND

A fastening assembly comprising a grommet and a pin is often used to connect two panel parts, such as panels of a vehicle. In some applications, the grommet is inserted and retained in a hole of one of the panels, and a shaft portion of the pin is inserted and retained in a receiving channel of the grommet. Thus, the fastening assembly is connected to one of the panels via the grommet, and the other panel is connected to a head portion of the pin. In this way, the fastening assembly connects the two panels together. In some other applications, the grommet is inserted and retained in holes of two stacked panels, and the shaft portion of the pin is inserted and retained in the receiving channel of the grommet. In this way, the fastening assembly connects the two panels together.

### SUMMARY

The present disclosure relates generally to a grommet, substantially as illustrated by and described in connection with at least one of the figures, as set forth more completely in the claims.

### BRIEF DESCRIPTION OF THE DRAWINGS

FIG. 1A is a perspective view of a fastening assembly including a grommet according to a first embodiment of the present disclosure in an assembled state;

FIG. 1B is a perspective view of the fastening assembly shown in FIG. 1A in an exploded state;

FIG. 2A is a perspective view from top of the grommet of the fastening assembly shown in FIG. 1A;

FIG. 2B is a top view of the grommet of the fastening assembly shown in FIG. 1A;

FIG. 2C is a perspective view from bottom of the grommet of the fastening assembly shown in FIG. 1A;

FIG. 3A is an axial cross-sectional view of the fastening assembly shown in FIG. 1A in an in-use state;

FIG. 3B is another axial cross-sectional view of the fastening assembly shown in FIG. 1A in the in-use state;

FIG. 4A is an axial cross-sectional view of the grommet shown in FIG. 2A being withdrawn from a hole of a part;

FIG. 4B is a top view and a partially enlarged view of the grommet shown in FIG. 4A; and

FIG. 5 is a perspective view of a grommet according to a second embodiment of the present disclosure.

### DETAILED DESCRIPTION OF EMBODIMENTS

Various specific embodiments of the present disclosure will be described below with reference to the drawings which form part of this specification. It should be understood that although the terms indicating directions, such as “front”, “rear”, “upper”, “lower”, “left”, “right”, “top”, and “bottom” are used in the present disclosure to describe structural parts and elements in various examples of the present disclosure, these terms are used herein only for ease of illustration and are determined based on the exemplary orientations shown in the accompanying drawings. Since the arrangements in the embodiments disclosed in the present disclosure may be in various directions, these terms indicating directions are only illustrative and should not be considered as limitations.

According to a first aspect of the present disclosure, the present disclosure provides a grommet, including a body, at least one first retaining portion, at least one second retaining portion and at least one operating portion. The body defines a receiving channel and a longitudinal axis, and includes a first axial body portion and a second axial body portion connected to each other. The first axial body portion includes at least one first body segment and at least one second body segment disposed about a longitudinal axis and spaced apart from each other. The at least one first retaining portion is provided on a side of the at least one first body segment facing away from the longitudinal axis. The at least one second retaining portion is provided at an end of the at least one second body segment away from the second axial body portion and extends away from the longitudinal axis. The at least one operating portion is provided at an end of the at least one first body segment away from the second axial body portion and extends away from the longitudinal axis. The grommet has a first state and a second state, and is switchable from the first state to the second state by operating the at least one operating portion to deflect the at least one first body segment toward the longitudinal axis and drive the at least one first retaining portion to move toward the longitudinal axis.

In the grommet according to the first aspect described above, the body includes at least two first body segments, each of which is provided with the first retaining portion and the operating portion. Each first body segment and the corresponding operating portion are configured such that when the grommet is switched to the second state, the first body segment and the corresponding operating portion do not interfere with other first body segments and the corresponding operating portions.

In the grommet according to the first aspect described, each first body segment and the corresponding operating portion is provided with a notch at least on a junction between the first body segment and the corresponding operating portion on at least one of two opposite side portions of the junction. The notch is configured such that when the grommet is switched to the second state, each first body segment and the corresponding operating portion do not interfere with other first body segments and the corresponding operating portions.

In the grommet according to the first aspect described, the notch spans an entire extension length of the operating portion.

In the grommet according to the first aspect described, the notch spans part of an extension length of the operating portion, so that the operating portion has a widened operating end.

In the grommet according to the first aspect described above, the body includes two first body segments, the two first body segments being disposed symmetrically with respect to the longitudinal axis.

In the grommet according to the first aspect described, each first body segment and the corresponding operating portion is provided with one notch, and the two notches are located on opposite sides of the two first body segments. The notch on one of the first body segments and the corresponding operating portion is configured to receive at least part of the other first body segment and the corresponding operating portion when the grommet is switched to the second state.

In the grommet according to the first aspect described, each of the two opposite side portions of each first body segment and the corresponding operating portion is provided with a notch.

In the grommet according to the first aspect described, the operating portion extends substantially perpendicular to the longitudinal axis.

In the grommet according to the first aspect described, the body is cylindrical.

In the grommet according to the first aspect described, the first body segment and the second body segment each extend in a circumferential direction and have a certain width.

According to a second aspect of the present disclosure, the present disclosure provides a fastening assembly for insertion into a hole of a part, including a pin, and a grommet according to the first aspect. The pin is at least partially inserted and retained in the receiving channel of the grommet. When the grommet is in the first state, the grommet is inserted into the hole of the part, and the first retaining portions and the second retaining portions are located on two opposite sides of the part, respectively; and when the grommet is in the second state, the first retaining portion is disengageable from the hole of the part, enabling the grommet to be withdrawn from the hole of the part.

In the present disclosure, the operating portion separated from the second retaining portion is provided, thereby avoiding removing the grommet from the connected part by operating the second retaining portion. Moreover, the operating portion can be configured in a shape or configuration that is easier for the operator to operate.

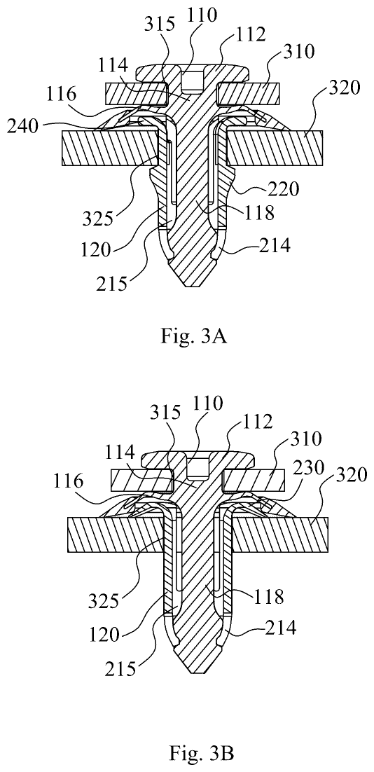

A fastening assembly including a grommet of the present disclosure is used to detachably connect two parts such as panels, for example, a first part 310 and a second part 320 shown in FIG. 3A.

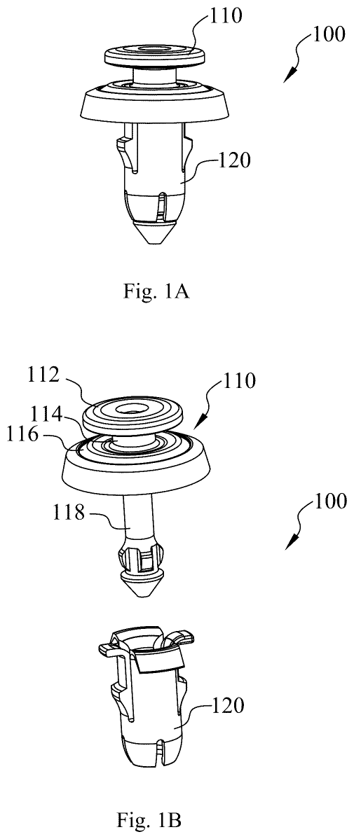

FIGS. 1A and 1B show an overall structure of a fastening assembly 100 including a grommet 120 according to a first embodiment of the present disclosure. FIG. 1A is a perspective view of the fastening assembly 100 in an assembled state and FIG. 1B is a perspective view of the fastening assembly 100 in an exploded state.

As shown in FIGS. 1A and 1B, the fastening assembly 100 includes a pin 110 and a grommet 120. The pin 110 can be at least partially inserted and retained in the grommet 120. The grommet 120 can be inserted and retained in a hole 325 of a second part 320 (as shown in FIG. 3A), and the pin 110 can be inserted and retained in a hole 315 of a first part 310 (as shown in FIG. 3A). In this way, the fastening assembly 100 can connect the first part 310 and the second part 320 to each other.

As shown in FIG. 1B, the pin 110 includes a head portion 112, a neck portion 114, a shoulder portion 116 and a shank portion 118, which are sequentially connected in its axial direction. An accommodating space surrounding the neck portion 114 is formed between the head portion 112 and the shoulder portion 116 for accommodating the first part 310 (as shown in FIG. 3A) between the head portion 112 and the shoulder portion 116.

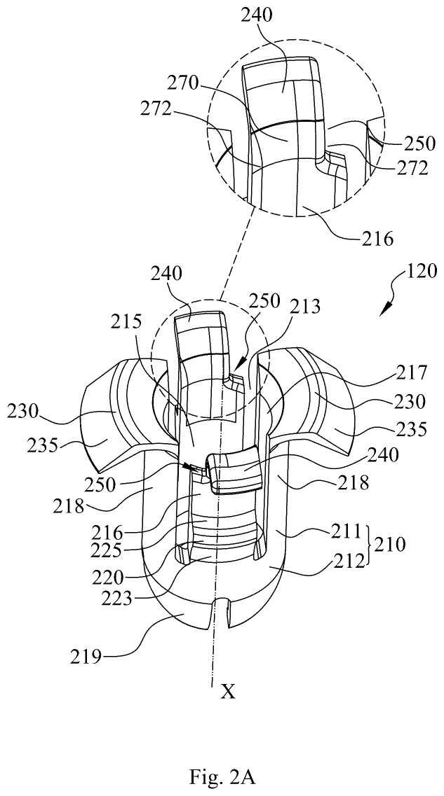

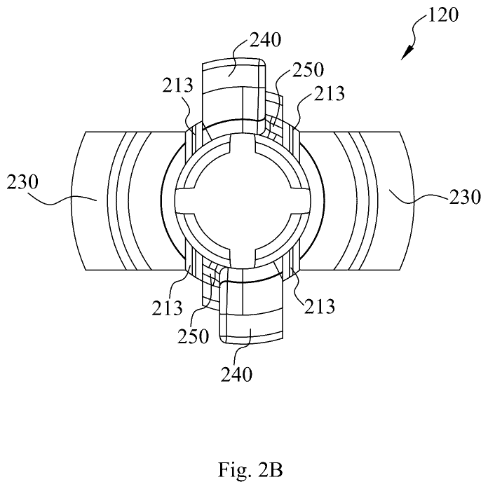

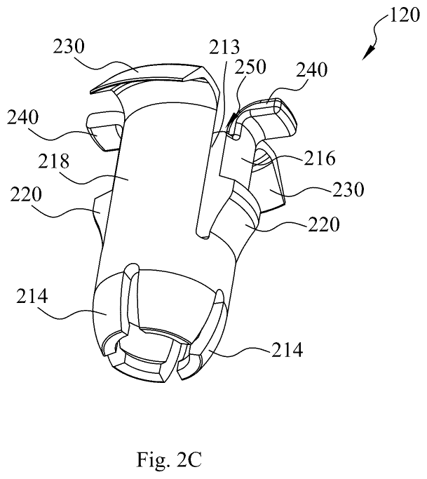

FIGS. 2A to 2C illustrate the specific structure of the grommet 120. FIG. 2A is a perspective view from top of the grommet 120, FIG. 2B is a top view of the grommet 120, and FIG. 2C is a perspective view from bottom of the grommet 120.

As shown in FIG. 2A, the grommet 120 includes a body 210. The body 210 is generally cylindrical, has a longitudinal axis X, and defines a receiving channel 215. The body 210 includes a first axial body portion 211 and a second axial body portion 212 connected to each other in its axial direction. The first axial body portion 211 and the second axial body portion 212 form a head end 217 and a tail end 219 of the body 210, respectively.

The body 210 further includes four slots 213. These four slots 213 divide the first axial body portion 211 in its circumferential direction to form two first body segments 216 and two second body segments 218. Therefore, the two first body segments 216 and the two second body segments 218 are separated from each other about the longitudinal axis X. The two first body segments 216 and the two second body segments 218 are both disposed symmetrically with respect to the longitudinal axis X of the body 210. Each first body segment 216 can be deflected toward the longitudinal axis X about an end thereof connected to the second axial body portion 212. The first body segments 216 and the second body segments 218 both extend for a distance in the circumferential direction.

The grommet 120 further includes two first retaining portions 220 and two second retaining portions 230 for retaining the grommet 120 in the hole 325 of the second part 320 (as shown in FIG. 3A). Specifically, the two first retaining portions 220 are respectively provided on sides (i.e., outer sides) of the two first body segments 216 of the body 210 facing away from the longitudinal axis X between the head end 217 and the tail end 219, and respectively protrude outward from the outer sides of the two first body segments 216. Each first retaining portion 220 has a first inclined surface 223 and a second inclined surface 225, which face the tail end 219 and the head end 217, respectively. The two inclined surfaces facilitate the insertion of the grommet 120 into the hole 325 of the second part 320 (as shown in FIG. 3A) or the withdrawal therefrom. The two first retaining portions 220 are disposed symmetrically with respect to the longitudinal axis X of the body 210.

The two second retaining portions 230 are respectively connected to the two second body segments 218 at the head end 217 of the body 210. The two second retaining portions 230 are generally in the shape of a partial umbrella and have walls 235 extending obliquely with respect to the longitudinal axis X toward the second axial body portion 212. The walls 235 can be deflected, thereby providing the second retaining portions 230 with a certain elasticity. Thus, when the grommet 120 is fixed to the second part 320 of different thickness (as shown in FIG. 3A), the second part 320 can be clamped between the second retaining portions 230 and the first retaining portions 220 by means of elastic deformation of the second retaining portions 230.

During the insertion of the grommet 120 into the hole 325 of the part 320 (as shown in FIG. 3A), the two first retaining portions 220 interact with an edge of the hole 325 via the first inclined surfaces 223 to drive the two first body segments 216 to deflect toward the longitudinal axis X, so that the two first retaining portions 220 pass through the hole 325 of the part 320 to a lower side of the part 320. When the grommet 120 is mounted in place in the hole 325 of the second part 320 (as shown in FIG. 3A), the first retaining portions 220 and the second retaining portions 230 are located on two opposite sides of the second part 320, respectively, thereby clamping the second part 320 therebetween. In the direction shown in FIG. 2A, the first retaining portions 220 are located below the second retaining portions 230.

Still as shown in FIG. 2A, the grommet 120 further includes two operating portions 240. The two operating portions 240 are respectively connected to the two first body segments 216 at the head end 217 of the body 210 and extend away from the longitudinal axis X. The two operating portions 240 are configured to be operated (for example, be pinched by hand) to move the two operating portions 240 toward each other and thus drive the two first body segments 216 to deflect toward the longitudinal axis X and toward each other. Since the two first retaining portions 220 are disposed on the two first body segments 216, when the two first body segments 216 are deflected toward each other, the two first retaining portions 220 thereon are driven to also move toward each other, thereby enabling the two first retaining portions 220 to disengage from the hole 325 of the part 320 and the grommet 120 to be removed from the hole 325 of the part 320.

Thus, the grommet 120 can switch between a first state and a second state. In the first state, the grommet 120 is inserted and retained in the hole 325 of the second part 320 as shown in FIG. 3A. In the second state, the two first body segments 216 of the grommet 120 are deflected such that the first retaining portions 220 can disengage from the hole 325 of the part 320, thereby enabling the grommet 120 to be removed from the hole 325 of the part 320.

As shown in FIGS. 2A and 2B, the two operating portions 240 extend substantially in a direction perpendicular to the longitudinal axis X. Compared with the second retaining portions 230, the two operating portions 240 are shorter and thicker, forming a handle-like structure, which makes the operating portions less prone to deformation and facilitates operation by an operator.

Still as shown in FIGS. 2A and 2B, the grommet 120 further includes two notches 250. The two notches 250 are configured such that when the grommet 120 is switched to the second state, one of the first body segments 216 and the corresponding operating portion 240 do not interfere with the other first body segment 216 and the corresponding operating portion 240. One of the notches 250 is provided on one of two circumferentially opposite side portions 272 of a junction 270 between one first body segment 216 and the corresponding operating portion 240 and spans an entire extension length of the operating portion 240. The other notch 250 is provided on one of two circumferentially opposite side portions 272 of a junction 270 between the other first body segment 216 and the corresponding operating portion 240 and spans the entire extension length of the operating portion 240. That is, only one of the two circumferentially opposite side portions 272 of the junction 270 between each first body segment 216 and the corresponding operating portion 240 is provided with a notch 250, and the other side portion has no notch. In addition, the two notches 250 are located on two opposite sides of the two first body segments 216. Thus, when the grommet 120 is switched to the second state, the notch 250 in one of the first body segments 216 and the corresponding operating portion 240 receives at least part of the other first body segment 216 and the corresponding operating portion 240.

Since the first body segments 216 and the corresponding operating portions 240 extend for a distance in the circumferential direction (i.e., have a certain width) about the longitudinal axis X, when the grommet 120 is in the second state, the circumferentially opposite side portions 272 of the junctions 270 between the two first body segments 216 and the corresponding operating portions 240 are more likely to come into contact with (or collide with) each other than other portions of the junctions 270. Thus, by providing the notches 250 described above, at least portions of the two first body segments 216 and the corresponding operating portions 240 that are prone to interference when the grommet 120 is in the second state are removed, thereby avoiding the interference.

As shown in FIGS. 2A and 2C, four claw portions 214 are provided on the tail end 219 of the body 210 of the grommet 120. The four claw portions 214 are disposed about the axis X of the body 210 and at a distance from one another, so that the four claw portions 214 can be deflected (or rotated) relative to each other. The claw portions 214 of the body 210 of the grommet 120 are used for cooperating with the pin 110 to retain the pin 110 in the grommet 120.

FIGS. 3A and 3B show a cooperation relationship between the fastening assembly 100 and the parts that are connected by the fastening assembly in an in-use state. FIG. 3A is an axial cross-sectional view of the fastening assembly 100 in the in-use state and FIG. 3B is another axial cross-sectional view of the fastening assembly 100 in the in-use state, where a sectioning direction in FIG. 3B is perpendicular to a sectioning direction in FIG. 3A.

As shown in FIGS. 3A and 3B, when the fastening assembly 100 connects the first part 310 and the second part 320 in place, the grommet is in the first state. The body 210 of the grommet 120 is inserted into the hole 325 of the second part 320, and the first retaining portions 220 and the second retaining portions 230 of the grommet 120 are located on lower and upper sides of the second part 320, respectively, and clamp the second part 320 therebetween, so that the grommet 120 is retained in the hole 325 of the second part 320. The shank portion 118 of the pin 110 is inserted into the receiving channel 215 of the body 210 of the grommet 120, and the claw portions 214 of the body 210 of the grommet 120 cooperate with the shank portion 118 of the pin 110 to retain the pin 110 in the grommet 120. The neck portion 114 of the pin 110 is inserted into a slot 315 of the first part 310, and the first part 310 is clamped between the head portion 112 and the shoulder portion 116 of the pin 110. Thus, the fastening assembly 100 connects the first part 310 and the second part 320 together. When the fastening assembly 100 connects the first part 310 and the second part 320 in place, the two operating portions 240 are located on the upper side of the second part 320 (as shown in FIG. 3A). Thus, the operator can access the operating portions 240 by hand.

In one embodiment, the steps of detaching the fastening assembly 100 from the first part 310 and the second part 320 are as follows.

Withdrawing the pin 110 from the grommet 120 first, and then withdrawing the grommet 120 from the second part 320. The grommet 120 is withdrawn from the second part 320 by the operator moving the two operating portions 240 toward each other.

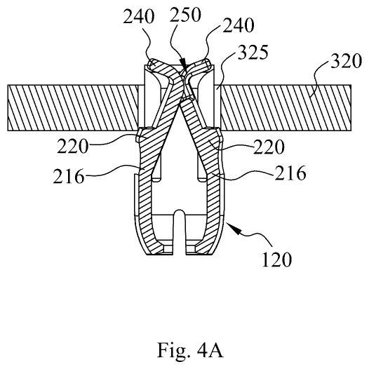

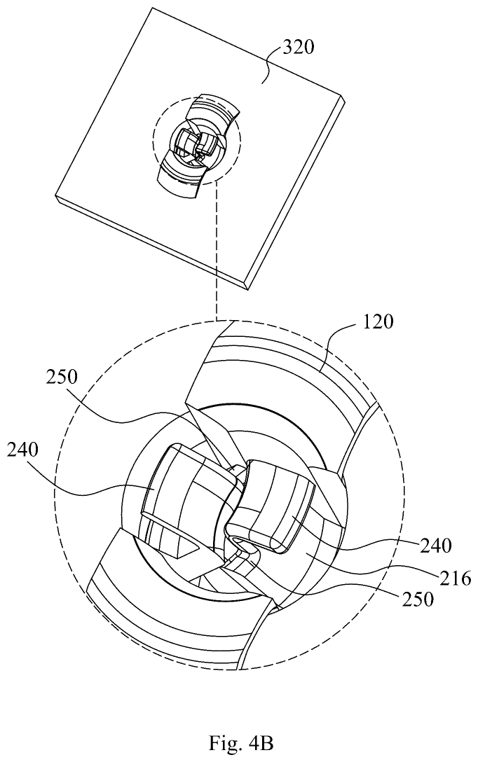

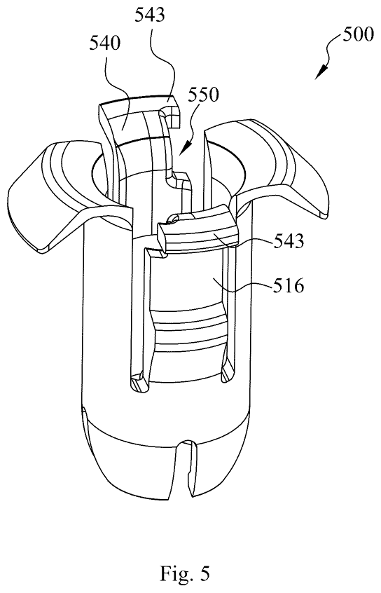

FIGS. 4A and 4B are an axial cross-sectional view and a top view, respectively, of the grommet 120 being withdrawn from the hole 325 of the second part 320, showing the grommet 120 in the second state, in which the first retaining portions 220 are disengageable from the hole 325 of the second part 320. In addition, a cooperation relationship between the notches 250 and the first body segments 216 and the corresponding operating portions 240 when the grommet 120 is in the second state is shown.

As shown in FIGS. 4A and 4B, during withdrawal of the grommet 120 from the hole 325 of the second part 320, the operator pinches the two operating portions 240 to move the two operating portions 240 toward each other and thus drive the two first body segments 216 of the body 210 to deflect toward each other. Since the two first retaining portions 220 are disposed on the two first body segments 216, the deflection of the two first body segments 216 toward each other causes the two first retaining portions 220 to move toward each other. As a result of the presence of the notches 250, the first body segments 216 and the corresponding operating portions 240 can partially move into the notches 250 facing the first body segments and the corresponding operating portions, which allows the two first body segments 216 to deflect toward each other to a greater extent and thus the two first retaining portions 220 to move toward each other to a greater extent. As a result, it is easier for the two first retaining portions 220 to enter the hole 325 of the second part 320, and thus it is easier for the grommet 120 to be withdrawn from the hole 325 of the second part 320.

FIG. 5 is a perspective view of a grommet 500 according to a second embodiment of the present disclosure. The grommet 500 shown in FIG. 5 is similar to the grommet 120 shown in FIGS. 2A to 2C, except that each notch 550 in the grommet 500 shown in FIG. 5 does not span an entire extension length of an operating portion 540, but only spans part of the extension length of the operating portion 540. This allows each operating portion 540 to have a widened operating end 543. The width of each operating end 543 is substantially the same as the width of the first body segment 516. By providing the widened operating ends 543, the contact area between the operator and the operating portions 543 can be increased, thereby enhancing the operational feel.

It should be noted that, although in the illustrated embodiments, the body of the grommet includes two first body segments provided with first retaining portions, in other embodiments, more or less first body segments provided with first retaining portions may be provided, as long as the first retaining portions can retain the grommet in the hole of the second part. Although in the illustrated embodiments, the body of the grommet includes two second body segments provided with second retaining portions, in other embodiments, more or less second body segments provided with second retaining portions may be provided, as long as the second retaining portions can retain the grommet in the hole of the second part.

Furthermore, it should be noted that, although in the illustrated embodiments, only one notch is provided on each first body segment and the corresponding operating portion, in other embodiments, two notches may be provided on each first body segment and the corresponding operating portion, and are located on the two circumferentially opposite side portions of the junction between the first body segment and the corresponding operating portion, respectively. The configuration in which only one notch is provided on each first body segment and the corresponding operating portion is more suitable for usage environments where the radial dimension of the grommet is small, as it can ensure the strength of the operating portions of the grommet while facilitating the withdrawal of the grommet. The configuration in which two notches are provided on each first body segment and the corresponding operating portion is more suitable for usage environments where the radial dimension of the grommet is larger.

It has been found that since the second retaining portion typically has a specific configuration, such as being shaped as an umbrella or a funnel, etc., to achieve the intended function thereof, removing the grommet from the connected part by operating the second retaining portion may be likely to damage the specific configuration of the second retaining portion so that the intended function of the second retaining portions cannot be achieved. In the present disclosure, the operating portion separated from the second retaining portion is provided, thereby avoiding removing the grommet from the connected part by operating the second retaining portion. Moreover, the operating portion can be configured in a shape or configuration that is easier for the operator to operate.

It has also found that, for the type of the grommet of the present disclosure, the positioning of the first retaining portion relative to the head end of the grommet is depending on the thickness of the second part to be connected. If the second part has a relatively large thickness, the first retaining portion is positioned farther away from the head end of the grommet. In this case, even if the first body segment provided with the first retaining portion can be deflected, if the extent of deflection is insufficient, it is not easy to withdraw the grommet from the hole of the second part. According to the fastening assembly of the present disclosure, a portion of the body of the grommet near the head end is divided into several circumferential segments in the circumferential direction, the first retaining portions and the operating portions are provided on some of the circumferential segments, and notches are provided on two circumferential side portions of the junctions between the circumferential segments and the corresponding operating portions, allowing the first retaining portions to move toward each other to a greater extent when the grommet is withdrawn from the hole of the second part, thereby facilitating easy detachment of the grommet from the connected part even when the fastening assembly is used for a connected part of a relatively large thickness.

Although the present disclosure is described with respect to the examples of embodiments outlined above, various alternatives, modifications, variations, improvements, and/or substantial equivalents that are known or current or to be anticipated before long may be obvious to those of at least ordinary skill in the art. In addition, the technical effects and/or technical problems described in this specification are exemplary rather than limiting; Therefore, the disclosure in this specification may be used to solve other technical problems and have other technical effects and/or may solve other technical problems. Accordingly, the examples of the embodiments of the present disclosure as set forth above are intended to be illustrative rather than limiting. Various changes can be made without departing from the spirit or scope of the present disclosure. Therefore, the present disclosure is intended to include all known or earlier developed alternatives, modifications, variations, improvements and/or basic equivalents.

### DESCRIPTION OF MAIN REFERENCE NUMBERS

Fastening assembly 100
Pin 110
Grommet 120
Head portion 112
Neck portion 114
Shoulder portion 116
Shank portion 118
Body 210
First axial body portion 211
Second axial body portion 212
Slot 213
Claw portion 214
Receiving channel 215
First body segment 216
Head end 217
Second body segment 218
Tail end 219
First retaining portion 220
First inclined surface 223
Second inclined surface 225
Second retaining portion 230
Wall 235
Operating portion 240
Notch 250
Junction 270
Side portion 272
First part 310
Slot 315
Second part 320
Hole 325
Grommet 500
First body segment 516
Operating portion 540
Notch 550
Operating end 543

What is claimed is:

1. A grommet, comprising:
a body defining a receiving channel and a longitudinal axis and comprising a first axial body portion and a second axial body portion connected to each other, the first axial body portion comprising at least one first body segment and at least one second body segment disposed about the longitudinal axis and spaced apart from each other;
at least one first retaining portion provided on a side of the at least one first body segment facing away from the longitudinal axis;
at least one second retaining portion provided at an end of the at least one second body segment away from the second axial body portion and extending away from the longitudinal axis; and
at least one operating portion provided at an end of the at least one first body segment away from the second axial body portion and extending away from the longitudinal axis,
wherein the grommet has a first state and a second state, and is switchable from the first state to the second state by operating the at least one operating portion to deflect the at least one first body segment toward the longitudinal axis and drive the at least one first retaining portion to move toward the longitudinal axis.

2. The grommet according to claim 1,
wherein the body comprises at least two first body segments, each of which is provided with the first retaining portion and the operating portion; and
wherein each first body segment and the corresponding operating portion are configured such that when the grommet is switched to the second state, the first body segment and the corresponding operating portion do not interfere with other first body segments and the corresponding operating portions.

3. The grommet according to claim 2, wherein each first body segment and the corresponding operating portion is provided with a notch at least on a junction between the first body segment and the corresponding operating portion on at least one of two opposite side portions of the junction, the notch being configured such that when the grommet is switched to the second state, each first body segment and the corresponding operating portion do not interfere with other first body segments and the corresponding operating portions.

4. The grommet according to claim 3, wherein the notch spans an entire extension length of the operating portion.

5. The grommet according to claim 3, wherein the notch spans part of an extension length of the operating portion, so that the operating portion has a widened operating end.

6. The grommet according to claim 3, wherein the body comprises two first body segments, the two first body segments being disposed symmetrically with respect to the longitudinal axis.

7. The grommet according to claim 6,
wherein each first body segment and the corresponding operating portion is provided with one notch, and the two notches are located on opposite sides of the two first body segments; and
wherein the notch on one of the first body segments and the corresponding operating portion is configured to receive at least part of the other first body segment and the corresponding operating portion when the grommet is switched to the second state.

8. The grommet according to claim 3, wherein each of the two opposite side portions of each first body segment and the corresponding operating portion is provided with a notch.

9. The grommet according to claim 1, wherein the operating portion extends substantially perpendicular to the longitudinal axis.

10. The grommet according to claim 1, wherein the body is cylindrical.

11. The grommet according to claim 10, wherein the first body segment and the second body segment each extend in a circumferential direction and have a certain width.

12. A fastening assembly for insertion into a hole of a part, comprising:
a pin; and
a grommet according to claim 1,
wherein the pin is at least partially inserted and retained in the receiving channel of the grommet; and
wherein when the grommet is in the first state, the grommet is inserted into the hole of the part, and the first retaining portion and the second retaining portion are located on two opposite sides of the part, respectively; and when the grommet is in the second state, the first retaining portion is disengageable from the hole of the part, enabling the grommet to be withdrawn from the hole of the part.
